(19) United States
(12) Patent Application Publication
(10) Pub. No.: US 2007/0043500 A1
(43) Pub. Date: Feb. 22, 2007

(54) Road Transport Information Monitoring and Personalized Reporting System

(76) Inventor: Shih H Chen, Yongkang City (TW)

Correspondence Address: HDSL, 4331 STEVENS BATTLE LANE, FAIRFAX, VA, 22033, US

(21) Appl. No.: 11/459,009

(22) Filed: Jul. 20, 2006

(30) Foreign Application Priority Data
Aug. 19, 2005 (TW) 094128397

(51) Int. Cl. G08G 1/00

(52) U.S. Cl. 701/117; 340/934

(57) ABSTRACT

A road transport information monitoring and personalized reporting system is carried in a car or built at a terminal display unit on a road, and data communication and transmission are conducted by a wireless transmission or a local area network to select a current traveling data at a specific road section based on the user's location. A plurality of section monitor units are distributed through a transmission control unit and the transmission control unit collects and transmits information to a control center through a communication medium. With the computation and analysis by software, the terminal display unit responds to a command directly from the control center or a command selected by users for a specific road section and delivers the information of the specific road section which includes the current traffic flow such as the density and speed of traveling motor vehicles at a specific road section.

### BACKGROUND OF THE INVENTION

1. Field of the Invention

The present invention relates to a road transport information monitoring and personalized reporting system, and more particularly to a road transport information monitoring and personalized reporting system that allows a user to use a terminal display unit to display and learn the information of current traveling conditions of a specified section or a set display section.

2. Description of Prior Art

Motor vehicles provide us a convenient transportation, but unexpected events occur inevitably while motor vehicles are traveling. For instance, road constructions, traffic controls, and traffic accidents create limitations or cause delays of a trip, and sometime cause inconvenience for traveler's physiological needs.

Therefore, most drivers try to detour or avoid certain road sections with the foregoing road conditions by listening to the broadcast of a road condition report of a radio or dialing a service call, or even using a satellite global positioning system, in hope of traveling quickly and safely to the destination.

However, most of these frequently tuned or used radio road condition reports and service calls provide the road conditions for a large section or the overall situation to meet the requirements of a vast majority of users. These road condition reports are usually broadcasted in a quick manner, and the interference of air waves gives rise to poor receiving quality. Furthermore, these reports are broadcasted in scheduled time intervals instead of continuously providing the report all the time, and drivers usually cannot timely control the actual road condition or the desired road condition of a specific road section. These reports cannot provide the road conditions for a specific road section to meet the driver's requirements, which is a drawback of the practical applications of the aforementioned methods. As to the satellite global position system, most of these systems provide a function of planning the best route or locating a specific geographical position, but they cannot specifically provide the road condition information of each road section. Cameras are installed on the highways and the control center to observe the traffic flow and road conditions, but all these are provided for the use by the control center or broadcast through a radio station. Thus, the aforementioned shortcomings including the incapability of timely providing the road condition information or providing the road condition information for a specific road section requested by drivers still cannot be overcome. Furthermore, the highway control center just uses signals at the road sections to indicate traffic flow and road conditions only.

Another device for providing instant road condition information as disclosed in R.O.C. Pat. Publication No. 581309 entitled “Instant road condition providing apparatus” adopts a microprocessor to compute the current geographical position through a global positioning unit and uses a wireless transmission receiving unit to receive and compare the received current geographical position with the location where the actual road conditions happen. The microprocessor selects the location where the actual road conditions happen and outputs the location through an output unit, and such structural design still has the following drawbacks:

1. The motor vehicles must have a global position unit with a radio transmission function, and thus it will incur an expense for remodeling the motor vehicles, and not all drivers are willing to do so.

2. Drivers have to drive around to receive the information. If a driver stops somewhere while the information is transmitted, errors will occur.

3. The population or percentage of installing and using the GPS system in conjunction with a transmission function is still very low, and this method cannot be carried out effectively.

### SUMMARY OF THE INVENTION

In view of the foregoing shortcomings of the prior art, the inventor of the present invention based on years of experience in the related industry to conduct experiments and modifications, and finally designed a road transport information monitoring and personalized reporting system to overcome the shortcomings of the prior art.

Therefore, the present invention is to overcome the shortcomings of the prior art by providing a road transport information monitoring and personalized reporting system that operates a terminal display unit to send a command for the report of the road condition information of a specific target road section and utilizes a radio transmission technology or a local area network to operate a control center, and a road section is adopted as a unit for collecting the monitor data, and a specific target road section is adopted for generating a report of data specified by a personal command.

In the road transport information monitoring and personalized reporting system of the invention, a specific road section is divided into a plurality of section monitor units, and the density and speed of traveling motor vehicles in the specific road section are monitored and transmitted by a transmission control unit. The information collected by the transmission control unit is sent to a control center through a communication medium. With the computation and analysis of a software design, the terminal display unit responds to a command directly from the control center or a command selected by users for the specific road section, and delivers the information of the specific road section to users. This data includes the current traffic flow such as the density and speed of the traveling motor vehicles at a specific road section.

In a preferred embodiment, the terminal display unit uses a portable image display device capable of transmitting and receiving signals, such as a palmtop computer, a personal digital assistant (PDA), a portable compute, or any other two-way transmission signal display device.

In another preferred embodiment, the terminal display unit uses a display device such as a color light signal billboard or a text/number display billboard capable of receiving, controlling and operating signals.

In a preferred embodiment, the control center is a server. The control center can instantly collect and record the data of the whole section and update the information according to the data collected by the control center through a road section design and the monitored, collected, and recorded data such as the speed and density of traveling motor vehicles at a specific road section.

The present invention provides a road transport information monitoring and personalized reporting system that comprises a plurality of section monitor units, a plurality of transmission control units, a control center, and a terminal display unit carried in a car or installed at the neighborhood of a road, and data communications and transmissions are conducted through a wireless transmission technology or a local area network. A plurality of section monitor units are distributed and built with an interval apart within the range of each road section for instantly monitoring the data such as the speed and density of traveling motor vehicles in a specific road section. A plurality of transmission control units provide a preliminary data of the data monitored by the plurality of section monitor units in a specific road section to conduct signal transmissions and controls with the control center. The control center carries out the processes of collecting, computing and recording all data transmitted from the transmission control unit and responding to the data requested by the terminal display unit. The terminal display unit sends out a command signal according to the current traveling data of a specific target road section or displays the section traveling data automatically transmitted and set up by the control center and responds to the data coming from the control center for users to read and access.

### BRIEF DESCRIPTION OF DRAWINGS

The features of the invention believed to be novel are set forth with particularity in the appended claims. The invention itself however may be best understood by reference to the following detailed description of the invention, which describes certain exemplary embodiments of the invention, taken in conjunction with the accompanying drawings in which:

FIG. 1 is a schematic view of the system architecture of a preferred embodiment of the present invention;

FIG. 2 is a schematic view of the layout of a sensor of a detecting element of the present invention;

FIG. 3 is a system block diagram of a preferred embodiment of the present invention; and

FIG. 4 is a schematic view of the layout of a terminal display unit of another preferred embodiment of the present invention.

### DETAILED DESCRIPTION OF THE INVENTION

The technical characteristics, features and advantages of the present invention will become apparent in the following detailed description of the preferred embodiments with reference to the accompanying drawings. However, the drawings are provided for reference and illustration only and are not intended for limiting the scope of the invention.

The road transport information monitoring and personalized reporting system in accordance with the present invention, the data including the speed and density of traveling motor vehicles in a road section is collected, and data communications and transmissions are conducted by a wireless transmission or a local area network, so that a user at a remote end can perform data communications and transmissions at any location by sending command signals or responding to the command through the wireless transmission technology or local area network, so as to obtain the display of a report of the required data including the speed and density of traveling motor vehicles in a specific target road section to generate a personalized road condition information report anytime.

Further, the road transport information monitoring and personalized reporting system in accordance with the present invention uses a section monitor unit with a data signal transmission technology to instantly monitor and collect data such as the speed and density of traveling motor vehicles at a remote end within the range of a road section, and the transmission control unit corresponding to a road section controls and sends signals to the control center through a communication medium. The control center uses these instant data of the road section to respond, and allows individual users at a remote end to retrieve the display of road traveling data captured at any location in a specific target road section, or display the road section traveling data directly through the terminal display unit such as a billboard set in a specific road section.

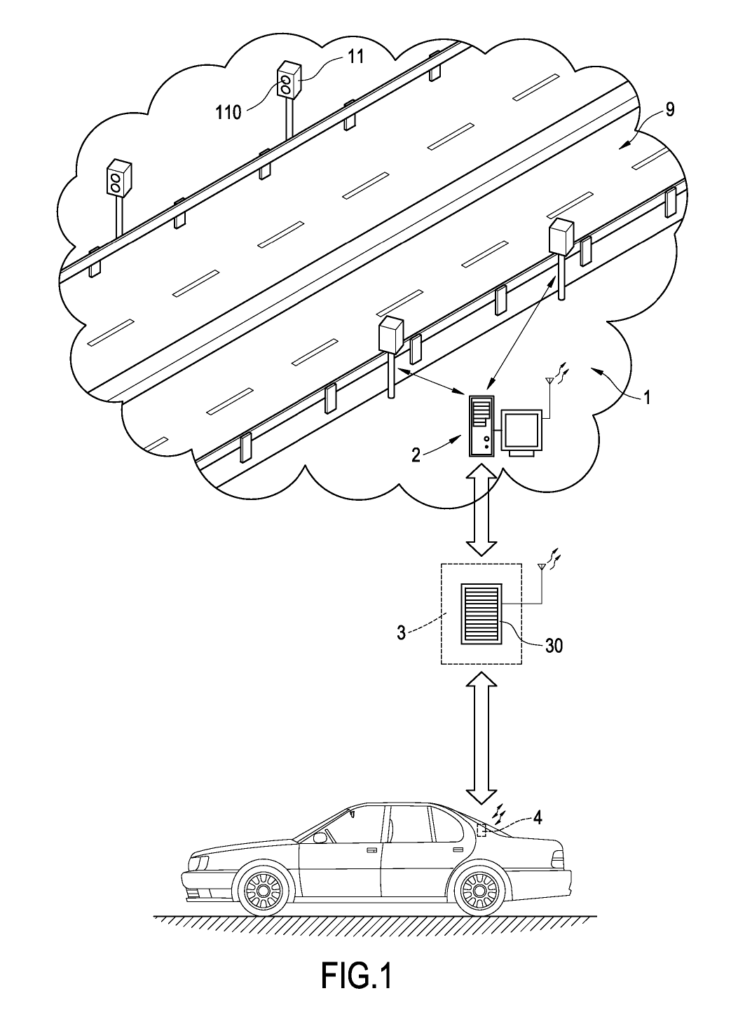

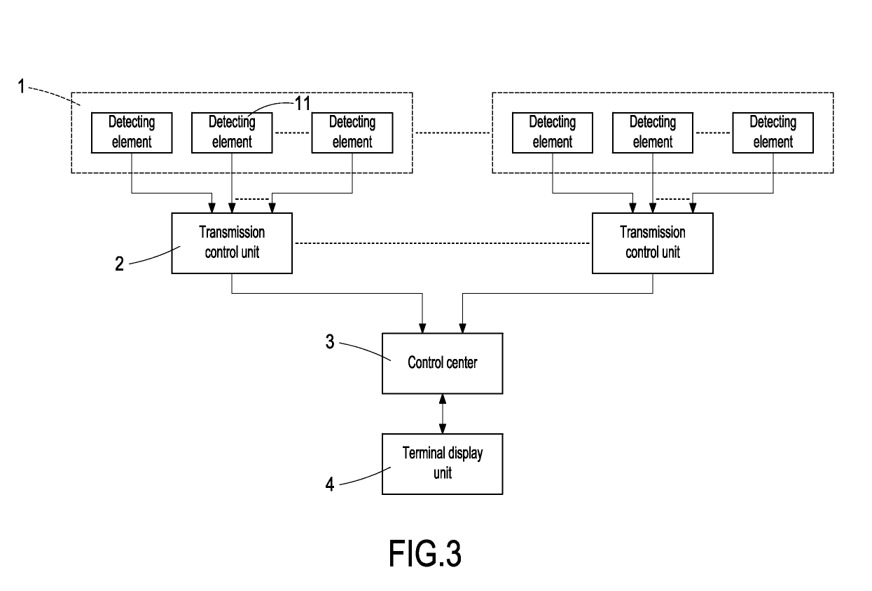

The primary technical content of a preferred embodiment of the present invention is disclosed and illustrated appropriately in the following examples. Referring to FIGS. 1 to 3 for a preferred embodiment of the road transport information monitoring and personalized reporting system in accordance with the invention, the road transport information monitoring and personalized reporting system comprises a plurality of section monitor units 1, a plurality of transmission control units 2, a control center 3 and a terminal display unit 4, and data communications and transmissions are conducted through a wireless transmission technology or a local area network. In an embodiment as shown in FIGS. 1 to 3, the plurality of section monitor units 1 are installed at a plurality of corresponding road section units, and a section monitor unit 1 installed at the unit road section 9 includes a plurality of detecting elements 11 disposed within the range of the foregoing unit road section 9 and arranged with an interval apart and serving as data monitoring access points, and the detecting elements 11 of these access points are installed with an interval apart for detecting the instant data such as the speed and density of traveling motor vehicles in a unit road section 9, and the transmission control unit 2 collects data monitored by the unit road section 9 through a wireless transmission technology.

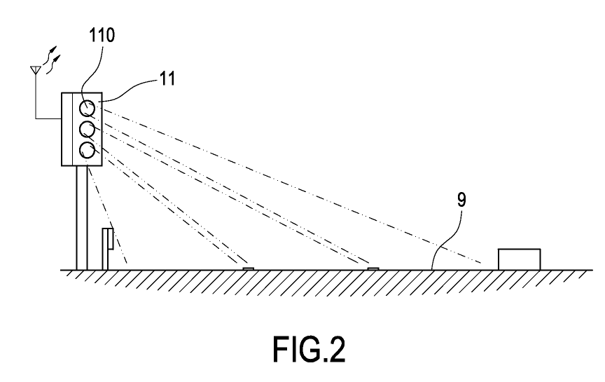

In another embodiment, a plurality of detecting elements 11 also can be built on both sides of a road as shown in FIG. 1, or installed at an interval apart to cope with the current detecting devices or road lamps. Of course, the foregoing installation positions are provided for illustration purpose only, and they can be modified according to the actual needs of the road environment. Further, the detecting element 11 of this embodiment includes one or more sensor 110 as shown in FIG. 2 and this embodiment uses a detecting element 11 having three sensors 110 corresponding to a separate lane in the predetermined detecting range. In fact, the quantity of sensors 110 installed in the detecting element 11 is preferably equal to the number of lanes of the road section. Of course, the quantity of sensors 110 is not limited to such arrangement, and a detecting element 11 having one sensor corresponding to a lane can be used as well.

The transmission technology provided for transmitting data between the detecting element 11 and the transmission control unit 2 can be conducted by a cable transmission or a TCP/IP communication protocol. Of course, other wireless transmission technologies such as RF communication module, Bluetooth communication protocol, or IEEE wireless communication protocol can be used for the data transmission as well.

A plurality of transmission control units 2 collects the data monitored by the plurality of detecting elements 11 corresponding to one or more unit road section 9 through a data transmission technology, and the transmission control unit 2 of this embodiment refers to a controller for collecting road section data and controlling and transmitting signals, and the transmission control unit 2 can control the data monitored and received by the plurality of detecting elements 11 to continuously send data signals to the control center 3.

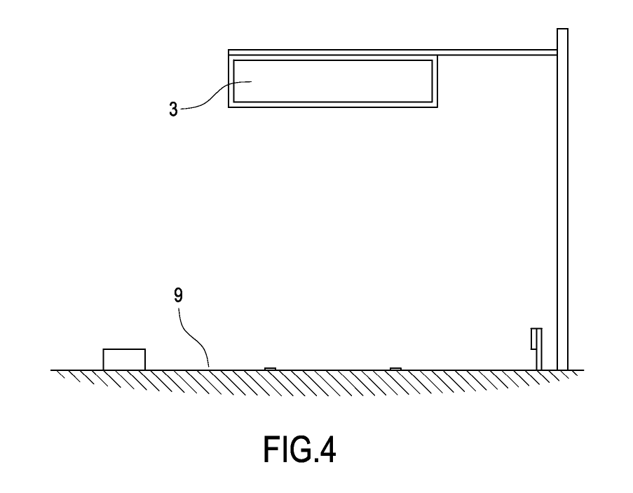

A control center 3 primarily collects the data such as the speed and density of traveling motor vehicles at each unit road section 9 transmitted by the transmission control unit 2, and a wireless transmission technology is used to receive and respond to a user's command signal to retrieve a data specified by the command and send the signal to the user's terminal display unit 4 for displaying the data. In an embodiment of the control center 3 as shown in FIGS. 1 and 4, the control center 3 installs a data recording and computing device 30 including a two-way transmission device such as a server for instantly computing and recording data to cope with the software program design and updating the data such as the speed and density of traveling motor vehicles in each unit road section 9 transmitted from each transmission control unit 2.

In an embodiment as shown in FIG. 1, a terminal display unit 4 refers to a data display device carried by a user or installed in a car, and the terminal display unit 4 uses a device with a wireless transmission technology to transmit an inquiry for target road section information selected by a user and receive and retrieve a return signal of the specified data and display the data on the display device. The terminal display unit 4 can be operated by a palmtop computer, a personal digital assistant (PDA), a stock machine, a portable computer with a global positioning system (GPS), a smart communication device, or a display device with a GPS or any other two-way transmission signal.

In another embodiment, the terminal display unit 4 could be a billboard as shown in FIG. 4, and built with an interval apart as a unit and disposed in a specific road section. The terminal display unit 4 and the billboard use a device with a cable transmission technology or a wireless transmission technology to transmit signals with the control center 3 to obtain the current traveling data in the specific road section. For the color light signals installed in a billboard, a red light indicates a traffic jam, a green light indicates a smooth traffic flow, and a yellow light indicates a traffic accident. Alternatively, numbers or texts with different fonts and font sizes can be used for the display, and the terminal display unit 4 can be a device that uses a color light signal billboard, a text display billboard, a number display billboard, a graphic billboard (such as a road map or a map) or any other one-way transmission signal for receiving and displaying the information.

The transmission between the transmission control unit 2 and the control center 3 and between the control center 3 and the terminal display unit 4 preferably adopts a wireless transmission technology and related devices to meet the requirements of a remote transmission. In another embodiment, a RF communication module, a wireless communication protocol, a Bluetooth communication protocol, or an IEEE wireless communication protocol can be used. Of course, the billboard of the terminal display unit 4 can be connected with cables.

In the operation according to a preferred embodiment of the present invention as shown in FIGS. 1 to 3, the current road conditions and traffic flow of a road can be detected by a plurality of section monitor units 1 installed in a road section, and each detecting element 11 instantly detects the data such as the speed and density of traveling motor vehicles in a specific unit road section 9 and transmits the data to each transmission control unit 2 by a transmission technology, and the transmission control unit 2 sends the data to the control center 3 through a transmission control to collect and compute the traveling data of each unit road section 9, so as to respond to the request and provide a personalized interface for selecting a display anytime. Users can input the current traffic condition information obtained from a road at any location anytime through a terminal display unit 4 installed in a car or carried by a user, and input a command for selecting the desired traffic condition information of a certain road section of a certain road. The target data select command is received by the control center 2 through the wireless transmission technology, and the control center 3 instantly retrieves and transmits the data such as the speed and density of traveling motor vehicles in the current specific target road section and displays the data directly after the terminal display unit 4 receives the data, so that users can know about the traffic conditions of a specific target road section.

If the terminal display unit 4 is a billboard, then the control center 3 connected to the billboard will instantly capture and transmit the current data such as the speed and density of traveling motor vehicles in a specific road section, such that after the terminal display unit 4 and the billboard receive the data, users can know about the current traffic conditions of the specific target road section.

In summation of the above description, the invention herein enhances the performance than the conventional structure and further complies with the patent application requirements.

The present invention are illustrated with reference to the preferred embodiment and not intended to limit the patent scope of the present invention. Various substitutions and modifications have suggested in the foregoing description, and other will occur to those of ordinary skill in the art. Therefore, all such substitutions and modifications are intended to be embraced within the scope of the invention as defined in the appended claims.

What is claimed is:

1. A road transport information monitoring and personalized reporting system, comprising:
a plurality of section monitor units, distributed and constructed in each predetermined road section, for promptly motoring time and density of motor vehicles passing through a range of the road section;
a plurality of transmission control units, for collecting a monitoring data of a plurality of monitor units in the predetermined road section, and transmitting control data;
a control center, for collecting the data transmitted from each of the transmission control units through a transmission device, and computing and recording the data by a software program; and
a terminal display unit, for receiving and displaying a sectional traveling data transmitted from the control center.

2. The road transport information monitoring and personalized reporting system of claim 1, wherein the section monitor unit includes a plurality of detecting elements arranged with an interval apart and disposed within a range of a sectional set unit road section.

3. The road transport information monitoring and personalized reporting system of claim 2, wherein the detecting element includes at least one sensor installed on both sides of a road or at a tall stand.

4. The road transport information monitoring and personalized reporting system of claim 2, wherein the data transmission between the detecting element and the transmission control unit is conducted by a transmission cable or a wireless transmission.

5. The road transport information monitoring and personalized reporting system of claim 1, wherein the transmission control unit is a controller that collects data in a road section and transmits and controls traveling signals.

6. The road transport information monitoring and personalized reporting system of claim 1, wherein the control center is a server which is a large data recording and computing device including a two-way transmission device for responding to a command of requesting target data of the terminal display unit and displaying replied specific target data on the terminal display unit.

7. The road transport information monitoring and personalized reporting system of claim 1, wherein the terminal display unit receives an input from a user, and sends a command for displaying target data inputted by the user, and displaying collected data received by the control center.

8. The road transport information monitoring and personalized reporting system of claim 1, wherein the terminal display unit is a two-way signal transmission display device or a one-way signal transmission display device.

9. The road transport information monitoring and personalized reporting system of claim 1, wherein the terminal display unit is a palmtop computer, a personal digital assistant (PDA), a global positioning system (GPS), a stock machine, or a fixed mount billboard.

10. The road transport information monitoring and personalized reporting system of claim 9, wherein the billboard adopts a color light signal, a font display or a graphic billboard (road map and map)

11. The road transport information monitoring and personalized reporting system of claim 1, wherein the transmission technology between the transmission control unit and the control center and between the control center and the terminal display unit is a wireless transmission or a cable transmission operated with related devices for remote transmission and operation.

12. A road transport information monitoring and personalized reporting system, comprising:
a plurality of access points, arranged and distributed with an interval apart and disposed on a predetermined position of a road for promptly monitoring data including time and density of passing motor vehicles;
a plurality of section data transmission control centers, for receiving the data from the plurality of access points in a specific road section, and sending the data;
a control center, for collecting, computing and recording the data transmitted from each section data transmission control center under a transmission control of a transmission technology, and a software program computing, recording and sending the data; and
a data display device, for receiving and displaying section traveling data transmitted from the control center.

13. The road transport information monitoring and personalized reporting system of claim 12, wherein a detecting element is installed separately at positions of the access points, and the plurality of access points are set above the road or on both sides of the road.

14. The road transport information monitoring and personalized reporting system of claim 12, wherein transmission between the access points and section data transmission control center is conducted by a transmission cable or wireless.

15. The road transport information monitoring and personalized reporting system of claim 12, wherein the section data transmission control center is a control center for transmitting data signals.
